(19) United States
(12) Patent Application Publication
(10) Pub. No.: US 2006/0181998 A1
(43) Pub. Date: Aug. 17, 2006

(54) METHOD AND APPARATUS FOR GENERATING A SAMPLING CLOCK FOR A BURST CUTTING AREA OF AN OPTICAL DISC

(76) Inventors: Chun-Nan Chen, Taipei City (TW); Wen-Yi Wu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,358

(22) Filed: Jun. 21, 2005

(30) Foreign Application Priority Data
Feb. 15, 2005 (TW) 094104330

(51) Int. Cl. G11B 5/09

(52) U.S. Cl. 369/59.19; 369/47.48

(57) ABSTRACT

A sampling clock generating device for a burst cutting area (BCA) of an optical disc is disclosed including: a detecting device for detecting a specific pulse period of a BCA reproducing signal reproduced from the BCA; and a clock generator electrically connected to the detecting device for generating a sampling clock according to the detected specific pulse period.

### BACKGROUND

The present invention relates to clock generation methods and related apparatus, and more particularly, to methods and apparatus for generating a sampling clock for a burst cutting area (BCA) of an optical disc.

FIG. 1 shows a schematic diagram of a conventional digital versatile disc (DVD) 100. As shown, a burst cutting area (BCA) 110 is formed near the center round hole of the DVD 100 for recording related information of the DVD 100. During BCA data writing, a laser beam is typically employed to remove the reflective film on a portion of the BCA 110. As a result, stripes of a barcode format are created. FIG. 2 shows an enlarged diagram 200 of a portion of the BCA 110. In FIG. 2, stripes 210˜260 are the areas in which the reflection films are removed by the laser beam. The data of the BCA 110 is generated by RZ (return to zero) modulation. In addition to the stripes, a dummy pit string also exists in the BCA 110. Therefore, the RF (radio frequency) signal reproduced from the BCA 110 by the pick-up unit of an optical disc drive includes not only a BCA stripe signal but also a high-frequency pit string signal, as shown in FIG. 3. In the related art, a BCA signal reproduction device is employed to process the RF signal reproduced from the BCA 110 to produce a BCA reproducing signal, which is also referred to as a BCA signal.

Then, a sampling clock is employed to sample the BCA reproducing signal for decoding the data of the BCA reproducing signal. The frequency and period of the BCA reproducing signal change with the rotation speed of the DVD 100. Thus, the data recorded in the BCA 110 can only be decoded correctly when the frequency of the sampling clock matches the frequency of the BCA reproducing signal. One of the conventional methods for decoding the data of the BCA reproducing signal is to detect the rotation speed of the spindle motor of the optical disc drive and to accordingly adjust the frequency of the sampling clock. In other words, the rotation speed of the spindle motor needs to be accurately detected in order to retrieve the data stored in the BCA 110.

Another conventional method for decoding the data of the BCA reproducing signal is to produce a sampling clock corresponding to the rotation speed of the spindle motor by utilizing a phase-locked loop (PLL). Unfortunately, an additional PLL is required in this method so that the complexity and cost are thereby increased.

### SUMMARY OF THE INVENTION

An exemplary embodiment of a sampling clock generating device for a burst cutting area (BCA) of an optical disc is disclosed comprising: a detecting device for detecting a specific pulse period of a BCA reproducing signal reproduced from the BCA; and a clock generator electrically connected to the detecting device for generating a sampling clock according to the detected specific pulse period.

An exemplary embodiment of a method for generating a sampling clock for a burst cutting area (BCA) of an optical disc is disclosed comprising: detecting a specific pulse period of a BCA reproducing signal reproduced from the BCA; and generating a sampling clock according to the detected specific pulse period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional digital versatile disc (DVD).

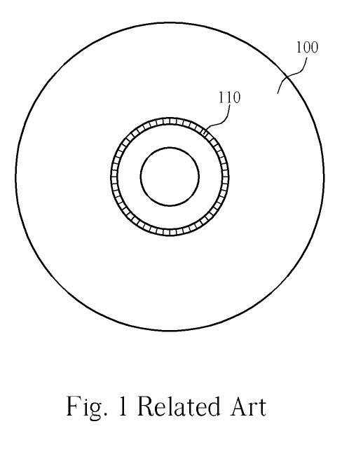

FIG. 2 is an enlarged diagram of a portion of the BCA of FIG. 1.

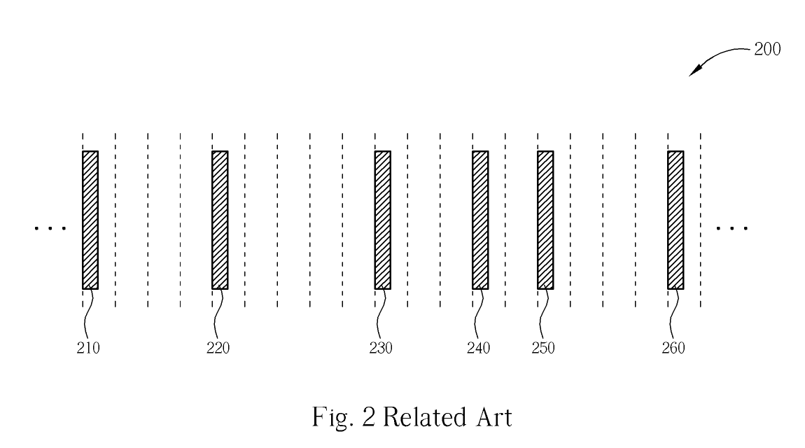

FIG. 3 is a schematic diagram of an RF signal reproduced from the BCA of FIG. 1 according to the related art.

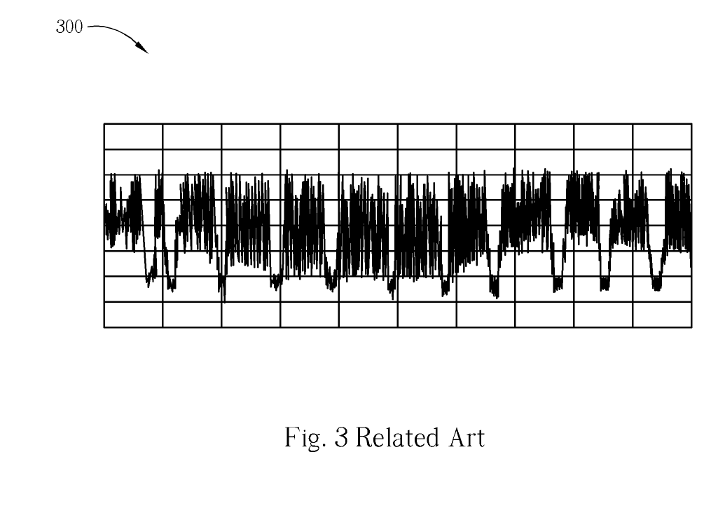

FIG. 4 is a block diagram of a sampling clock generating device for a BCA of an optical disc according to an exemplary embodiment of the present invention.

FIG. 5 is a flowchart illustrating a method for generating a sampling clock for the BCA according to an exemplary embodiment of the present invention.

FIG. 6 is a schematic diagram of a BCA reproducing signal generated by a BCA signal reproduction device of FIG. 4 in accordance with the present invention.

### DETAILED DESCRIPTION

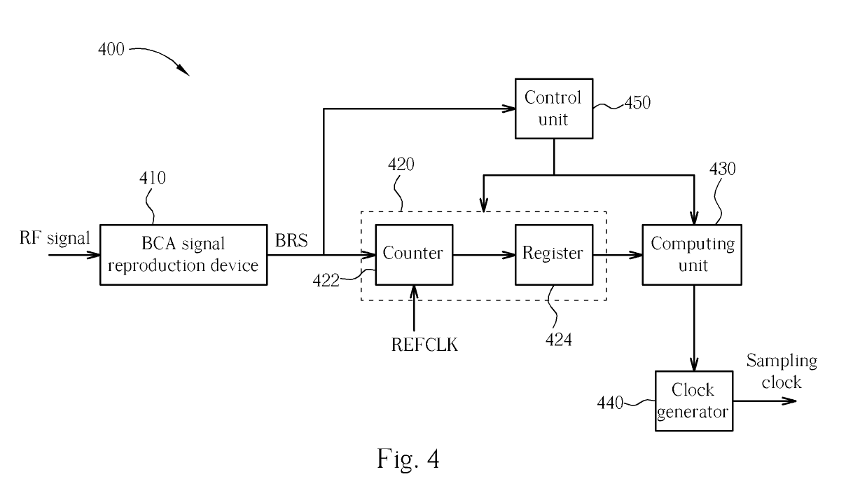

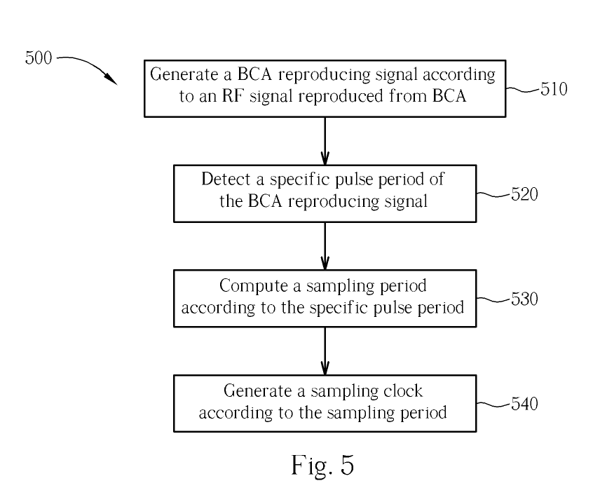

Please refer to FIG. 4, which shows a block diagram of a sampling clock generating device 400 for a burst cutting area (BCA) of an optical disc according to an exemplary embodiment of the present invention. In this embodiment, the sampling clock generating device 400 comprises a BCA signal reproduction device 410; a detecting device 420 electrically connected to the BCA signal reproduction device 410; a computing unit 430 electrically connected to the detecting device 420; and a clock generator 440 electrically connected to the computing unit 430 for generating a sampling clock. Hereinafter, operations of the sampling clock generating device 400 will be explained with reference to FIG. 5.

FIG. 5 is a flowchart 500 illustrating a method for generating a sampling clock for the BCA 110 according to an exemplary embodiment of the present invention. The flowchart 500 comprises the following steps.

Step 510: Generate a BCA reproducing signal according to an RF signal reproduced from the BCA 110.

Step 520: Detect a specific pulse period of the BCA reproducing signal.

Step 530: Compute a sampling period according to the specific pulse period.

Step 540: Generate a sampling clock according to the sampling period.

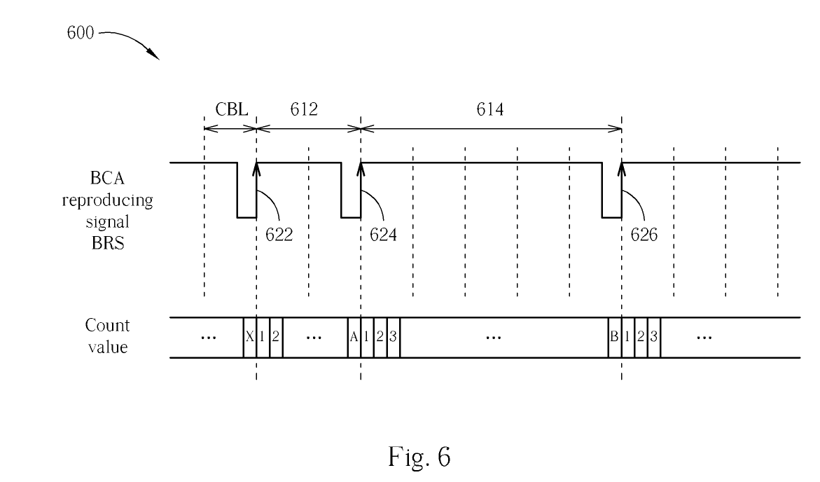

In step 510, the BCA signal reproduction device 410 generates a BCA reproducing signal BRS as shown in FIG. 6 according to an RF signal reproduced from the BCA 110. In practice, the BCA signal reproduction device 410 of the sampling clock generating device 400 can be implemented with a defect detector. For example, the defect detector of an optical disc drive can be employed in the sampling clock generating device 400 to generate a defect signal as the BCA reproducing signal BRS according to the RF signal. The operations of generating the defect signal as the BCA reproducing signal BRS are well known in the art and further details are therefore omitted for brevity. Of course, the BCA reproducing signal BRS can also be produced through other known or future techniques.

Then, in step 520, the detecting device 420 detects a specific pulse period of the BCA reproducing signal BRS. As shown in FIG. 6, the length of pulse period of the pulses of the BCA reproducing signal BRS are not identical. For example, a pulse period 612 is shorter than another pulse period 614. In addition, the length of pulse period of each pulse of the BCA reproducing signal BRS varies with the rotation speed of the optical disc, i.e., the rotation speed of the spindle motor of the optical disc drive. However, the relationship between the length of each pulse period of the BCA reproducing signal BRS and a BCA channel bit length CBL is fixed. In the embodiment shown in FIG. 6, for example, the pulse period 612 is always twice the length of the BCA channel bit length CBL while the pulse period 614 is always five times the length of the BCA channel bit length CBL regardless of the rotation speed of the optical disc. Therefore, once a specific pulse period of the BCA reproducing signal BRS is detected by the detecting device 420, the BCA channel bit length CBL can be accordingly derived from the specific pulse period.

For convenience of description, it is assumed that the detecting device 420 is designed to detect the maximum pulse period of the BCA reproducing signal BRS in step 520. In a preferred embodiment shown in FIG. 4, the detecting device 420 comprises a counter 422 and a register 424 electrically connected to the counter 422. In step 520, the counter 422 employs a reference clock REFCLK as the working clock and performs a counting operation based on the reference clock REFCLK. When the counter 422 is triggered by the rising edge of the BCA reproducing signal BRS, the counter 422 outputs a count value and resets its counting operation. For example, the counter 422 outputs a count value X and resets its counting operation when it is triggered by a rising edge 622. When the counter 422 is triggered by a rising edge 624, it outputs a count value A and resets the counting operation thereof. Next, when the counter 422 is triggered by a rising edge 626, it outputs a count value B and resets the counting operation. In practice, the reference clock REFCLK can be implemented with a system clock. Additionally, the counter 422 can be designed to output a count value and to reset its counting operation when it is triggered by the falling edge of the BCA reproducing signal BRS. In other words, the counter 422 of the detecting device 420 is arranged for performing a counting operation according to edges of the BCA reproducing signal BRS to generate a plurality of count values.

Once the counter 422 outputs a new count value being greater than the count value stored in the register 424, the register 424 updates the stored count value with the new count value so as to record the maximum one of the plurality of count values from the counter 422.

In this embodiment, since the pulse period of the reference clock REFCLK is a given value, the maximum count value stored in the register 424 can be utilized to represent the maximum pulse period of the BCA reproducing signal BRS. For example, if the pulse period 614 shown in FIG. 6 is the maximum pulse period of the BCA reproducing signal BRS, then the length of the pulse period 614 can be represented by the count value B. Next, in step 530, the computing unit 430 computes a sampling period according to the specific pulse period detected by the detecting device 420. In this embodiment, the specific pulse period is represented by the count value B. In the case of the blu-ray disc standard, the maximum pulse period of the BCA reproducing signal BRS is five times the length of the BCA channel bit length CBL. Accordingly, computing unit 430 can obtain the ratio of the BCA channel bit length CBL to the clock period of the reference clock REFCLK by dividing the count value B by 5. For example, if the count value B is 100, then the BCA channel bit length CBL is 20 (=100/5) times the length of the clock period of the reference clock REFCLK. In practice, the computing unit 430 may be implemented with a divider or a multiplier. Additionally, the function of the computing unit 430 can also be realized by using software means. In this embodiment, the sampling clock generating device 400 employs the computing result obtained from the computing unit 430 as a sampling period, i.e., the sampling period is 20 times the length of the clock period of the reference clock REFCLK.

In the case of the HD-DVD standard, the maximum pulse period of the BCA reproducing signal BRS is four times the length of the BCA channel bit length CBL. Accordingly, computing unit 430 can obtain a corresponding sampling period by dividing the count value B by 4.

In step 540, the clock generator 440 generates a sampling clock according to the sampling period, so that the following stage can sample the BCA reproducing signal BRS based on the sampling clock to decode the data stored in the BCA 110.

As in the foregoing descriptions, when the rotation speed of the optical disc changes, the pulse period of each pulse of the BCA reproducing signal BRS correspondingly changes, and the BCA channel bit length CBL also proportionally changes. Accordingly, the ratio of the maximum pulse period of the BCA reproducing signal BRS to the BCA channel bit length CBL retains a fixed value. In the aforementioned embodiment, the BCA channel bit length CBL can be accurately calculated through detecting the maximum pulse period of the BCA reproducing signal BRS, and then a corresponding sampling clock can thereby be produced. Note that the disclosed method is not limited to detecting the maximum pulse period of the BCA reproducing signal BRS. In fact, the second maximum pulse period, the minimum pulse period, or any other specific pulse period of the BCA reproducing signal BRS also has a constant relationship to the BCA channel bit length CBL, so any one of these pulse periods can be employed as the detection object in step 520.

In a preferred embodiment, the sampling clock generating device 400 further comprises a control unit 450 as shown in FIG. 4. The control unit 450 is arranged for stopping the operations of the detecting device 420 or the computing unit 430. For example, when the detecting device 420 operates over a predetermined period, the specific pulse period (e.g., the maximum pulse period) of the BCA reproducing signal BRS should be detected completely, and the BCA channel bit length CBL should be obtained by the sampling clock generating device 400. In this situation, the control unit 450 stops the operation of the detecting device 420, the counter 422, or the computing unit 430 so as to maintain the sampling clock generated from the clock generator 440 in a fixed frequency. In practice, the control unit 450 may count the pulse number of the BCA reproducing signal BRS and stop the operation of the detecting device 420, the counter 422, or the computing unit 430 when the pulse number reaches a predetermined threshold.

The method for generating the sampling clock for the BCA in accordance with the present invention does not require related information of the rotation speed of the spindle motor of the optical disc drive, so that the complexity of circuitry control is significantly reduced. In addition, the circuit complexity and cost of the optical disc drive can be reduced due to no additional phase-locked loop (PLL) being required.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sampling clock generating device for a burst cutting area (BCA) of an optical disc, comprising:
a detecting device for detecting a specific pulse period of a BCA reproducing signal reproduced from the BCA; and
a clock generator electrically connected to the detecting device for generating a sampling clock according to the detected specific pulse period.

2. The sampling clock generating device of claim 1, further comprising:
a computing unit electrically connected to the detecting device and the clock generator for computing a sampling period according to the specific pulse period;
wherein the clock generator generates the sampling clock according to the sampling period.

3. The sampling clock generating device of claim 2, wherein the computing unit is a divider for dividing the specific pulse period by a predetermined value to obtain the sampling period.

4. The sampling clock generating device of claim 2, wherein the detecting device comprises:
a counter for performing a counting operation according to edges of the BCA reproducing signal to generate a plurality of count values;
wherein the specific pulse period corresponds to one of the plurality of count values.

5. The sampling clock generating device of claim 4, wherein the detecting device further comprises:
a register electrically connected to the counter for recording a maximum value of the plurality of count values.

6. The sampling clock generating device of claim 4, wherein the counter performs the counting operation according to either rising or falling edges of the BCA reproducing signal.

7. The sampling clock generating device of claim 4, further comprising:
a control unit for counting pulse number of the BCA reproducing signal and for controlling the counter or the computing unit to halt operation when the pulse number of the BCA reproducing signal reaches a predetermined value.

8. The sampling clock generating device of claim 4, further comprising:
a control unit electrically connected to the detecting device for controlling the counter or the computing unit to halt operation when the detecting device operates over a predetermined period.

9. The sampling clock generating device of claim 2, wherein the computing unit is a multiplier.

10. The sampling clock generating device of claim 1, further comprising:
a control unit electrically connected to the detecting device for controlling the detecting device to halt operation when the detecting device operates over a predetermined period.

11. The sampling clock generating device of claim 1, wherein the specific pulse period is a maximum pulse period of the BCA reproducing signal.

12. The sampling clock generating device of claim 1, further comprising:
a BCA signal reproduction device electrically connected to the detecting device for generating the BCA reproducing signal according to an RF signal reproduced from the BCA.

13. The sampling clock generating device of claim 1, further comprising:
a defect detector electrically connected to the detecting device for generating a defect signal as the BCA reproducing signal according to an RF signal reproduced from the BCA.

14. A method for generating a sampling clock for a burst cutting area (BCA) of an optical disc, the method comprising:
detecting a specific pulse period of a BCA reproducing signal reproduced from the BCA; and
generating a sampling clock according to the detected specific pulse period.

15. The method of claim 14, wherein the step of generating the sampling clock comprises:
computing a sampling period according to the specific pulse period; and
generating the sampling clock according to the sampling period.

16. The method of claim 15, wherein the step of computing the sampling period comprises:
dividing the specific pulse period by a predetermined value to obtain the sampling period.

17. The method of claim 15, wherein the step of detecting the specific pulse period comprises:
performing a counting operation according to edges of the BCA reproducing signal to generate a plurality of count values;
wherein the specific pulse period corresponds to one of the plurality of count values.

18. The method of claim 17, wherein the step of detecting the specific pulse period further comprises:
recording a maximum value of the plurality of count values to represent the specific pulse period.

19. The method of claim 17, further comprising:
counting pulse number of the BCA reproducing signal; and
halting the counting operation or stopping the step of computing the sampling period when the pulse number of the BCA reproducing signal reaches a predetermined value.

20. The method of claim 17, further comprising:
halting the counting operation or stopping the step of computing the sampling period when the step of detecting the specific pulse period is performed over a predetermined period.

21. The method of claim 14, further comprising:
stopping the step of detecting the specific pulse period when it is performed over a predetermined period.

22. The method of claim 14, wherein the specific pulse period is a maximum pulse period of the BCA reproducing signal.

23. The method of claim 14, further comprising:
generating the BCA reproducing signal according to an RF signal reproduced from the BCA.

24. The method of claim 14, further comprising:
utilizing a defect detector to generate a defect signal as the BCA reproducing signal according to an RF signal reproduced from the BCA.
